(19) United States
(12) Patent Application Publication
(10) Pub. No.: US 2017/0106396 A1
(43) Pub. Date: Apr. 20, 2017

(54) Adhesive Applying Head, Adhesive Applying Device and Manufacture Method for Touch-Control Display Panel

(71) Applicants: BOE TECHNOLOGY GROUP CO., LTD., Beijing (CN); BOE (HEBEI) MOBILE DISPLAY TECHNOLOGY CO., LTD., Gu'An, Hebei (CN)

(72) Inventor: Dapeng WANG, Beijing (CN)

(73) Assignees: Boe Technology Group Co., Ltd., Bejing (CN); Boe (HEBEI) Mobile Display Technology Co., Ltd., Hebei (CN)

(21) Appl. No.: 15/107,335

(22) PCT Filed: Jan. 7, 2016
(86) PCT No.: PCT/CN2016/070325

§ 371 Date: Jun. 22, 2016

(30) Foreign Application Priority Data
Apr. 9, 2015 (CN) 201510166736.0

(51) Int. Cl. B05C 5/02

(52) U.S. Cl. CPC B05C 5/027; B05C 11/10

(57) ABSTRACT

Disclosed are adhesive applying head, adhesive applying device and manufacture method for touch-control display panel. The head comprises: an adhesive supply pipe connected to adhesive supply system and configured to introduce adhesive fluid; a flow split part including flow split pipes having equal length, first ends of flow split pipes being connected to adhesive supply pipe and second ends thereof being arranged in a row; a flow guide part including flow guide pipes, the number of flow guide pipes being equal to that of flow split pipes, first ends of flow guide pipes being connected to second ends of the flow split pipes, respectively, and second ends thereof being connected to the adhesive discharge part; and an adhesive discharge part having a cavity formed with adhesive outlet. Therefore, adhesive discharged amount in each region of the adhesive outlet is equal, thereby improving uniformity of discharged adhesive of the head.

### FIELD OF THE INVENTION

The disclosure relates to the field of display technologies, and in particular to an adhesive applying head, an adhesive applying device and a manufacture method of touch-control display panel.

### BACKGROUND OF THE INVENTION

Generally, a touch-control display panel (for example, a touch display screen of an intelligent mobile phone) includes a display panel and a touch-control substrate which are laminated together. The lamination of the display panel and the touch-control substrate may include two methods which are full-lamination and edge-lamination. Compared with the edge-lamination, the touch-control display panel using the full-lamination may provide reduction of reflective light, improvement of glaring light and increase in brightness. When the display panel and the touch-control substrate are attached by using the full-lamination, it is required to coat the display panel and/or the touch-control substrate with LOCA (Liquid Optical Clear Adhesive). After the LOCA is solidified, the display panel and the touch-control substrate are laminated together, which means a touch-control display substrate is produced.

In a manner, the LOCA is applied by an adhesive dispenser. Disadvantage of the adhesive dispenser is in that overflowed adhesive may he formed. After laminating, there is a need to clean up the overflowed adhesive. Therefore a great deal of manual labour may be consumed and it is inclined to cause damage, scratch and deficiency of the display panel.

In another manner, the LOCA is applied by surface coating. The adhesive applying device for surface coating has a linear adhesive outlet. The adhesive outlet can be moved in a direction perpendicular to a longitudinal direction thereof while being applied. It should be understood that the adhesive outlet could also be moved in a direction at an included angle with respect to the longitudinal direction thereof. The included angle could be ranged from 0 to 90 degrees. The adhesive fluid can be discharged from the adhesive outlet by aforesaid process to complete surface coating with the LOCA.

However, in above applying manners, the length of the adhesive outlet is usually larger than a diameter of an adhesive supply pipe. In this case, each point on the linear adhesive outlet has different distance from the adhesive supply pipe. As such, in unit time, flow amount of the adhesive fluid supplied to each point on the adhesive outlet from the adhesive supply pipe and discharged from each point on the adhesive outlet may be different. In other words, an amount of discharged adhesive at each point on the adhesive outlet may be different. Generally speaking, a middle portion of the linear adhesive outlet has a greater amount of discharged adhesive, while two ends thereof have a fewer amount of discharged adhesive. Therefore, the conventional surface coating may lead to a problem of uneven adhesive applying.

### SUMMARY OF THE INVENTION

To address at least one of the technical problems in the prior art, the disclosure provides an adhesive applying head, an adhesive applying device and a manufacture method for touch-control display panel so as to improve the uniformity of the adhesive applying.

To achieve an objective of the disclosure, there is provided an adhesive applying head, comprising an adhesive supply pipe, a flow split part, a flow guide part and an adhesive discharge part; the adhesive supply pipe is connected to an adhesive supply system and configured to introduce adhesive fluid; the flow split part includes a plurality of flow split pipes having an equal length, first ends of the flow split pipes being connected to the adhesive supply pipe and second ends thereof being arranged in a row; the flow guide part includes a plurality of flow guide pipes, the number of the flow guide pipes being equal to that of the flow split pipes, first ends of flow guide pipes being connected to second ends of the flow split pipes, respectively, and second ends thereof being connected to the adhesive discharge part; and the adhesive discharge part has a cavity which is formed with an adhesive outlet.

Preferably, the plurality of flow guide pipes are linearly arranged in parallel and flush at two terminals thereof.

Preferably, any adjacent two flow guide pipes have equal intervals.

Preferably, the adhesive outlet is formed into a linear shape extending in the longitudinal direction, and the width of the adhesive outlet is 1.5 mm.

Preferably, the plurality of flow split pipes are tightly connected to the adhesive supply pipe or formed integrally therewith; and the plurality of flow split pipes are tightly connected to the plurality of flow guide pipes, respectively, or formed integrally therewith.

Preferably, the adhesive discharge part has an open/close unit for opening and/or closing the adhesive outlet; and the open/close unit includes a block mechanism and a drive mechanism, wherein the block mechanism is disposed in the cavity of the adhesive discharge part and configured to seal the adhesive outlet, and the drive mechanism is configured to drive the block mechanism such that the adhesive outlet is closed or opened.

Preferably, the block mechanism has a cylinder structure or a semi-cylinder structure, the block mechanism is arranged along the longitudinal direction of the adhesive outlet and an arc side of the block mechanism faces the adhesive outlet.

Preferably, the block mechanism is made from butadiene-acrylonitrile rubber.

As another technical solution, in the disclosure there is also provided an adhesive applying device. The adhesive applying device comprises the aforesaid adhesive applying head according to the disclosure.

As another technical solution, in the disclosure there is also provided a manufacture method for touch-control display panel, comprising a step of coating a display panel and/or touch-control substrate with an adhesive. At this step, the aforesaid adhesive applying device according to the disclosure can be used to apply the adhesive to the display panel and/or touch-control substrate.

The embodiment of the disclosure may have following advantageous effects:

In the adhesive applying head according to the disclosure, the adhesive fluid within the adhesive supply pipe can be uniformly into the plurality of the flow split pipes and dispensed to various regions in the cavity of the adhesive discharge part via the plurality of flow split pipes. Therefore, it is possible to improve the uniformity of the amount of discharged adhesive in each region of the adhesive outlet, thereby improving the uniformity of the adhesive applying.

Since the adhesive applying device according to the disclosure employs the aforesaid adhesive applying head according to the disclosure, it is possible to improve the uniformity of the adhesive applying.

Since the method for manufacturing touch-control display panel according to the disclosure employs the aforesaid adhesive applying device according to the disclosure to apply the adhesive to the display panel and/or touch-control substrate, it is possible to improve the uniformity of the adhesive applying, thereby improving the fastness of the lamination between the display panel and the touch-control substrate while assisting in improving the display quality of the touch-control display panel.

### BRIEF DESCRIPTION OF THE DRAWINGS

Accompanying drawings are provided for further understanding of the disclosure and constituting a part of the specification. Hereinafter, these drawings are intended to explain the disclosure together with the following specific embodiments, but should not be considered as a limitation of the disclosure. In which:

FIG. 1 is a schematic diagram illustrating an adhesive applying head according to an embodiment of the disclosure; and

FIG. 2 is a schematic diagram illustrating an adhesive discharge part in the adhesive applying head as shown in FIG. 1.

### DETAILED DESCRIPTION OF THE EMBODIMENTS

Hereinafter, specific embodiments of the disclosure will be described in detail in conjunction with the accompanying drawings. It should be understood that the specific embodiments as set forth herein are merely for the purpose of illustration and explanation of the disclosure and should not be constructed as a limitation thereof.

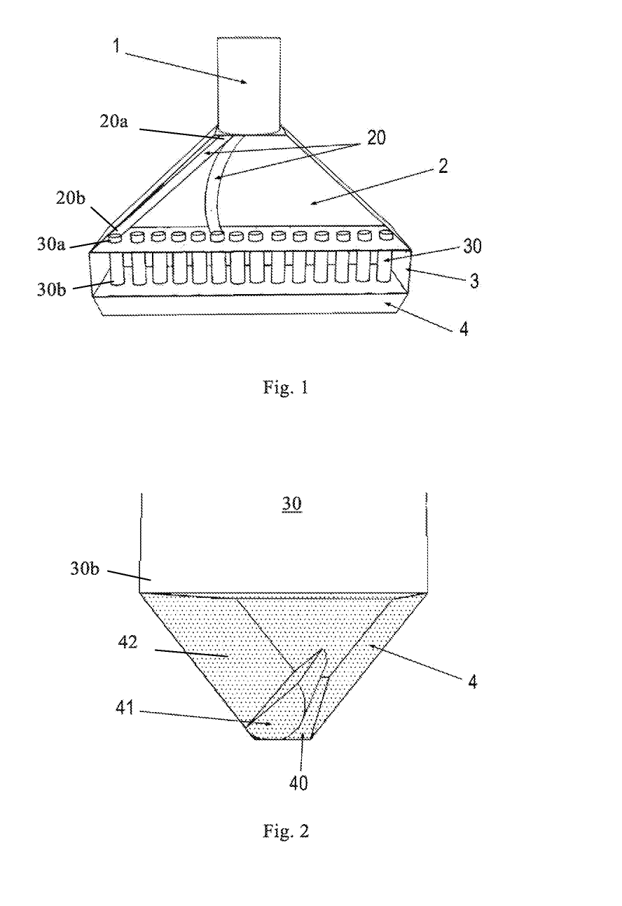

In one embodiment of the disclosure there is provided an adhesive applying head. FIG. 1 is a schematic diagram illustrating an adhesive applying head according to the embodiment of the disclosure; and FIG. 2 is a schematic diagram illustrating an adhesive discharge part in the adhesive applying head as shown in FIG. 1. As shown in FIG. 1 and FIG. 2, in this embodiment, the adhesive applying head may include an adhesive supply pipe 1, a flow split part 2, a flow guide part 3 and a adhesive discharge part 4, wherein the adhesive supply pipe 1 is connected to an adhesive supply system (not shown) and configured to introduce adhesive fluid; the flow split part 2 includes a plurality of flow split pipes 20 having an equal length (for the purpose of a simple and clear figure, FIG. 1 only schematically represents two flow split pipes), first ends 20a of the flow split pipes 20 being connected to the adhesive supply pipe 1 and second ends 20b thereof being arranged in a row; the flow guide part 3 includes a plurality of flow guide pipes 30, the number of the flow guide pipes 30 being equal to that of the flow split pipes 20, first ends 30a of flow guide pipes 30 being connected to second ends 20b of the flow split pipes 20, respectively, and second ends 30b thereof being connected to the adhesive discharge part 4; and the adhesive discharge part 4 has a cavity 42 which is formed with an adhesive outlet 40.

In general, the adhesive supply pipe 1 of the adhesive applying head is communicated with the adhesive supply system (not shown), and in turn the adhesive supply system provides the adhesive applying head with the adhesive fluid such that the adhesive applying head can complete the application of adhesive fluid. In this embodiment, during the application of the adhesive by the adhesive applying head, the adhesive fluid supplied from the adhesive supply system may firstly be introduced to the adhesive supply pipe 1; then the adhesive fluid within the adhesive supply pipe 1 may be uniformly introduced into the plurality of flow split pipes 20 in connection with the adhesive supply pipe 1; subsequently, the adhesive fluid within each flow split pipe 20 may be introduced into the respective flow guide pipe 30 in connection with the flow split pipes 20; and in the end, the adhesive fluid within the plurality of flow guide pipes 30 may be guided into the cavity of the adhesive discharge part 4. When the adhesive outlet 40 formed on the cavity of the adhesive discharge part 4 is opened, the adhesive fluid may be discharged from the adhesive outlet 40 to achieve the application of adhesive.

In this embodiment, the plurality of flow split pipes 20 are tightly connected to the adhesive supply pipe 1 and preferably formed integrally therewith; and the plurality of flow split pipes 20 are tightly connected to the plurality of flow guide pipes 30, respectively, and preferably formed integrally.

In another embodiment, each of flow split pipes 20 may be directly communicated with the cavity of the adhesive discharge part 4. In this case, a portion of the flow split pipe 20 which is communicated with the cavity of the adhesive discharge part 4 can be used as the flow guide pipe.

In this embodiment, the plurality of flow split pipes 20 are all connected to the adhesive supply pipe 1. Therefore, the adhesive fluid within the adhesive supply pipe 1 may be uniformly or substantially uniformly introduced to the plurality of flow split pipes 20. In other words, the adhesive fluid is dispensed into each flow split pipe 20 at equal or substantially equal flow amount. In the meanwhile, the adhesive fluid is dispensed into each flow split pipe 20 at equal or substantially equal flow rate. In this embodiment, the flow split pipes 20 have equal length. In this case, the adhesive fluid passes through each flow split pipe 20 with the same time. Thus, within unit time, an equal flow amount of the adhesive fluid is introduced into the flow guide pipes 30 via the flow split pipes 20. Therefore, the plurality of flow guide pipes 30 may introduce an equal flow amount of the adhesive fluid to various regions in the cavity of the adhesive discharge part 4, such that the adhesive fluid introduced into the cavity of the adhesive discharge part 4 can be uniformly discharged from each region of the adhesive outlet 40. In such a manner, it is possible to improve the uniformity of the amount of discharged adhesive in each region of the adhesive outlet 40, thereby improving the uniformity of the adhesive applying.

In this embodiment, as shown in FIG. 1, the plurality of flow guide pipes 30 are linearly arranged in parallel and flush at two terminals thereof. Such an arrangement can ensure that the adhesive fluid within each flow guide pipe 30 is kept at the same flow rate. In such a manner, it is possible to assist in improving the uniformity of the adhesive fluid introduced into each region in the cavity of the adhesive outlet 40, thereby further improving the uniformity of the amount of discharged adhesive in each region of the adhesive outlet 40.

In addition, any adjacent two flow guide pipes 30 have equal intervals. In such an arrangement, the adhesive fluid can be distributed into each region in the cavity of the adhesive outlet 40 while the flow of the adhesive fluid in the cavity can be reduced, assisting in improving the uniformity of the discharged adhesive in each region of the adhesive outlet 40.

The adhesive outlet 40 is formed into a linear shape extending in the longitudinal direction. In other words, the adhesive outlet 40 is narrow such that the size in its longitudinal direction is much larger than that in its width direction. In such an arrangement, the adhesive fluid discharged from the adhesive outlet 40 is formed in a line. When the adhesive applying head according to the embodiment is moved in a direction perpendicular to or oblique with respect to a longitudinal direction of the adhesive outlet 40 (for example, the movement direction of the adhesive applying head and the longitudinal direction of the adhesive outlet 40 has an included angle of 0-90 degrees), the adhesive fluid can be uniformly applied to the surface of the substrate.

Preferably, in this embodiment, the width of the adhesive outlet 40 is about 1.5 mm.

As shown in FIG. 2, the adhesive discharge part 4 may further include an open/close unit for opening and/or closing the adhesive outlet 40; the open/close unit may include a block mechanism 41 and a drive mechanism (not shown in figure), wherein the block mechanism 41 is disposed in the cavity of the adhesive discharge part 4 and configured to seal the adhesive outlet 40, and the drive mechanism is configured to drive the block mechanism 41 such that the adhesive outlet 40 is closed or opened. In particular, as shown in FIG. 2, the block mechanism 41 has a cylinder structure or a semi-cylinder structure (only the semi-cylinder structure is shown in FIG. 2). The block mechanism is arranged along the longitudinal direction of the adhesive outlet 40 and an arc side of the block mechanism faces the adhesive outlet 40.

Preferably, the block mechanism 41 may be made from butadiene-acrylonitrile rubber. The butadiene-acrylonitrile rubber has good oil-resistance, anti-static electricity and gas-tightness. The block mechanism 41 made from butadiene-acrylonitrile rubber may have good tightness. Since the block mechanism 41 may tightly seal the adhesive outlet 40, it is possible to prevent the adhesive fluid flowing from the adhesive outlet 40 and becoming dry when the adhesive applying head is not used.

In the adhesive applying head according to the embodiment of the disclosure, the adhesive fluid within the adhesive supply pipe 1 can be uniformly into the plurality of the flow split pipes 20 and dispensed to various regions in the cavity of the adhesive discharge part 4 via the plurality of flow split pipes 20. Therefore, it is possible to improve the uniformity of the amount of discharged adhesive in each region of the adhesive outlet 40, thereby improving the uniformity of the adhesive applying.

In another embodiment of the disclosure there is provided an adhesive applying device. In this embodiment, the adhesive applying device may include the adhesive applying head according to above embodiment of the disclosure.

Since the adhesive applying device according to this embodiment of the disclosure employs the aforesaid adhesive applying head according to the embodiment of the disclosure, it is possible to improve the uniformity of the adhesive applying.

In another embodiment of the disclosure there is provided a method for manufacturing touch-control display panel. In this embodiment, the method for manufacturing touch-control display panel may include a step of coating a display panel and/or touch-control substrate with an adhesive. In particular, at this step, the aforesaid adhesive applying device according to the embodiment of the disclosure is used to apply the adhesive to the display panel and/or touch-control substrate.

Since the method for manufacturing touch-control display panel according to this embodiment of the disclosure employs the aforesaid adhesive applying device according to the embodiment of the disclosure to apply the adhesive to the display panel and/or touch-control substrate, it is possible to improve the uniformity of the adhesive applying, thereby improving the fastness of the lamination between the display panel and the touch-control substrate while assisting in improving the display quality of the touch-control display panel.

It should be understood that the above implementations are merely exemplary embodiments for the purpose of illustrating the principle of the disclosure, and the disclosure is not limited thereto. Various modifications and improvements can be made by a person having ordinary skill in the art without departing from the spirit and essence of the disclosure. Accordingly, all of the modifications and improvements also fall into the protection scope of the disclosure.

1-10. (canceled)

11. An adhesive applying head, wherein it comprises an adhesive supply pipe, a flow split part, a flow guide part and an adhesive discharge part;
the adhesive supply pipe is connected to an adhesive supply system and configured to introduce adhesive fluid;
the flow split part includes a plurality of flow split pipes having an equal length, first ends of the flow split pipes being connected to the adhesive supply pipe and second ends thereof being arranged in a row;
the flow guide part includes a plurality of flow guide pipes, the number of the flow guide pipes being equal to that of the flow split pipes, first ends of flow guide pipes being connected to second ends of the flow split pipes, respectively, and second ends thereof being connected to the adhesive discharge part; and
the adhesive discharge part has a cavity which is formed with an adhesive outlet.

12. The adhesive applying head according to claim 11, wherein the plurality of flow guide pipes are linearly arranged in parallel and flush at two terminals thereof.

13. The adhesive applying head according to claim 11, wherein any adjacent two flow guide pipes have equal intervals.

14. The adhesive applying head according to claim 11, wherein the adhesive outlet is formed into a linear shape extending in the longitudinal direction, and the width of the adhesive outlet is 1.5 mm.

15. The adhesive applying head according to claim 11, wherein, the plurality of flow split pipes are tightly connected to the adhesive supply pipe or formed integrally therewith; and the plurality of flow split pipes are tightly connected to the plurality of flow guide pipes, respectively, or formed integrally therewith.

16. The adhesive applying head according to claim 11, wherein the adhesive discharge part has an open/close unit for opening and/or closing the adhesive outlet; and
the open/close unit includes a block mechanism and a drive mechanism, wherein the block mechanism is disposed in the cavity of the adhesive discharge part and configured to seal the adhesive outlet, and the drive mechanism is configured to drive the block mechanism such that the adhesive outlet is closed or opened.

17. The adhesive applying head according to claim 16, wherein the block mechanism has a cylinder structure or a semi-cylinder structure, the block mechanism is arranged along the longitudinal direction of the adhesive outlet and an arc side of the block mechanism faces the adhesive outlet.

18. The adhesive applying head according to claim 17, wherein the block mechanism is made from butadiene-acrylonitrile rubber.

19. An adhesive applying device, wherein the adhesive applying device comprises the adhesive applying head according to claim 11.

20. The adhesive applying device according to claim 19, wherein the plurality of flow guide pipes are linearly arranged in parallel and flush at two terminals thereof.

21. The adhesive applying device according to claim 19, wherein any adjacent two flow guide pipes have equal intervals.

22. The adhesive applying device according to claim 19, wherein the adhesive outlet is formed into a linear shape extending in the longitudinal direction, and the width of the adhesive outlet is 1.5 mm.

23. The adhesive applying device according to claim 19, wherein the plurality of flow split pipes are tightly connected to the adhesive supply pipe or formed integrally therewith; and
the plurality of flow split pipes are tightly connected to the plurality of flow guide pipes, respectively, or formed integrally therewith.

24. The adhesive applying device according to claim 19, wherein the adhesive discharge part has an open/close unit for opening and/or closing the adhesive outlet; and
the open/close unit includes a block mechanism and a drive mechanism, wherein the block mechanism is disposed in the cavity of the adhesive discharge part and configured to seal the adhesive outlet, and the drive mechanism is configured to drive the block mechanism such that the adhesive outlet is closed or opened.

25. The adhesive applying device according to claim 24, wherein the block mechanism has a cylinder structure or a semi-cylinder structure, the block mechanism is arranged along the longitudinal direction of the adhesive outlet and an arc side of the block mechanism faces the adhesive outlet.

26. The adhesive applying device according to claim 25, wherein the block mechanism is made from butadiene-acrylonitrile rubber.

27. A manufacture method for touch-control display panel, comprising a step of coating a display panel and/or touch-control substrate with an adhesive, wherein at this step, the adhesive applying device according to claim 19 is used to apply the adhesive to the display panel and/or touch-control substrate.

28. The method according to claim 27, wherein any adjacent two flow guide pipes have equal intervals.

29. The method according to claim 27, wherein the plurality of flow split pipes are tightly connected to the adhesive supply pipe or formed integrally therewith; and the plurality of flow split pipes are tightly connected to the plurality of flow guide pipes, respectively, or formed integrally therewith.

30. The method according to claim 27, wherein the adhesive discharge part has an open/close unit for opening and/or closing the adhesive outlet; and
the open/close unit includes a block mechanism and a drive mechanism, wherein the block mechanism is disposed in the cavity of the adhesive discharge part and configured to seal the adhesive outlet, and the drive mechanism is configured to drive the block mechanism such that the adhesive outlet is closed or opened.
